(19) United States
(12) Patent Application Publication
(10) Pub. No.: US 2022/0138643 A1
(43) Pub. Date: May 5, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yu Nagata, Chofu-shi Tokyo-to (JP); Shin Sakurada, Toyota-shi Aichi-ken (JP); Satoshi Komamine, Nagoya-shi Aichi-ken (JP); Yusuke Sato, Nagoya-shi Aichi-ken (JP); Hiromitsu Fujii, Kariya-shi Aichi-ken (JP)

(21) Appl. No.: 17/513,120

(22) Filed: Oct. 28, 2021

(30) Foreign Application Priority Data
Nov. 2, 2020 (JP) 2020-183727

(51) Int. Cl. G06Q 10/06; G06Q 50/30; G06Q 10/02; G06Q 10/08; H04W 4/38

(52) U.S. Cl. CPC G06Q 10/0631; G06Q 50/30; H04W 4/38; G06Q 10/0832; G06Q 10/02

(57) ABSTRACT

An information processing apparatus disclosed manages dispatch of a vehicle to a user. The information processing apparatus includes a controller configured to forecast a property of baggage (e.g. the sizes and the number of bags) that the user will carry when going out somewhere. Moreover, the controller sends offer information to a terminal used by the user. The offer information is information for offering dispatch of a type of vehicle that is suitable for the forecast property of the baggage.

### CROSS-REFERENCE TO RELATED APPLICATIONS

This application claims the benefit of Japanese Patent Application No. 2020-183727, filed on Nov. 2, 2020, which is hereby incorporated by reference herein in its entirety.

### BACKGROUND

### Technical Field

The present disclosure relates to an information processing apparatus, an information processing method, and a non-transitory storage medium.

### Description of the Related Art

There is a known system that receives a vehicle dispatch request with information about the number of passengers and the amount of baggage from a user and selects a vehicle to be dispatched on the basis of the number of passengers and the amount of baggage (see, for example, Patent Literature 1 in the citation list below).

### CITATION LIST

### Patent Literature

Patent Literature 1: Japanese Patent Application Laid-Open NO. 2019-067247

### SUMMARY

An object of this disclosure is to provide a technology that enables efficient dispatch of a vehicle to a user who intends to go out somewhere.

Disclosed herein is an information processing apparatus for managing dispatch of a vehicle to a user. The information processing apparatus may comprise, for example, a controller including at least one processor, the controller being configured to execute the processing of:

forecasting a property of baggage that the user will carry when going out somewhere; and

sending offer information to a terminal used by the user, the offer information being information for offering dispatch of a type of vehicle that is suitable for the forecast property of the baggage.

Also disclosed herein is an information processing method for managing dispatch of a vehicle to a user. The information processing method may comprise, for example, the following steps of processing executed by a computer:

a first step of forecasting a property of baggage that the user will carry when going out somewhere; and

a second step of sending offer information to a terminal used by the user, the offer information being information for offering dispatch of a type of vehicle that is suitable for the forecast property of the baggage.

Also disclosed herein is an information processing program for implementing the above-described information processing method and a non-transitory storage medium in which this information processing program is stored.

This disclosure provides a technology that enables efficient dispatch of a vehicle to a user who intends to go out somewhere.

### BRIEF DESCRIPTION OF DRAWINGS

FIG. 1 is a diagram illustrating the general configuration of a vehicle dispatch system.

FIG. 2 is a block diagram illustrating exemplary configurations of a server apparatus, a user's terminal, and a sensor included in a vehicle dispatch system according to an embodiment.

FIG. 3 illustrates an exemplary message displayed on the user's terminal that has received offer information.

FIG. 4 illustrates an exemplary structure of a bag information table according to the embodiment.

FIG. 5 illustrates an exemplary structure of a taxi information table.

FIG. 6 is a flow chart of a process executed by the server apparatus according to the embodiment.

FIG. 7 is a block diagram illustrating exemplary configurations of a server apparatus, a user's terminal, and a sensor included in a vehicle dispatch system according to a first modification.

FIG. 8 illustrates an exemplary structure of a bag information table according to the first modification.

FIG. 9 is a block diagram illustrating exemplary configurations of a server apparatus, a user's terminal, and a sensor included in a vehicle dispatch system according to a second modification.

### DESCRIPTION OF EMBODIMENTS

The technology disclosed herein is characterized by forecasting a property of baggage that a user will carry when going out somewhere and offering dispatch of a type of vehicle that is suitable for the forecast property of the baggage to the user.

If a vehicle with a relatively small baggage space is dispatched to a user who intends to go out somewhere with a relatively large amount of baggage or a relatively large number of pieces of baggage, there is a possibility that the baggage the user carries cannot be loaded into the vehicle. If a vehicle with a relatively large baggage space is dispatched to user who intends to go out somewhere with a relatively small amount of baggage or a relatively small number of pieces of baggage, there is a possibility that a wasteful empty space may be left in the baggage space of the vehicle, though it is possible to load the baggage the user carries into the vehicle.

One possible solution to the above problems is to select a vehicle to be dispatched based on information about the size and the number of pieces of baggage that the user who intends to go out somewhere will carry. In the case where this method is employed, if the user is required to provide the information about the size and the number of pieces of the baggage, it may be troublesome for the user to make a request for dispatch of a vehicle. If the user does not provide appropriate information, it may sometimes be impossible to dispatch a vehicle suitable for the size and the number of pieces of baggage. Thus, efficient dispatch of vehicles to users who intend to go out somewhere is desired.

An information processing apparatus disclosed herein has a controller configured to forecast a property of baggage that a user will carry when going out somewhere. The controller sends information for offering dispatch of a type of vehicle that is suitable for the forecast property of the baggage to a terminal used by the user. This information will be also referred to as “offer information” hereinafter. The terminal used by the user may be a terminal carried by the user or a stationary terminal set in the user's home. If the user accepts the offer presented by the offer information, the user may send a response indicating his/her acceptance of the offer through the aforementioned terminal. Thus, it is possible to dispatch a type of vehicle that is suitable for the property of the baggage while saving the user the effort of providing information about the property of the baggage. Moreover, it is possible to prevent a vehicle that is not suitable for the property of the baggage from being dispatched due to the absence of appropriate information provided by the user. Therefore, the technology disclosed herein enables efficient dispatch of vehicles to users who intend to go out somewhere.

The property of baggage defined in this disclosure may include information about the sizes and the number of bags that the user will carry when going out somewhere. In this case, the controller may forecast the sizes and the number of bags the user will carry when going out somewhere by determining the sizes and the number of bags that the user has packed before going out somewhere on the basis of information acquired by a certain sensor. Thus, the controller can offer a vehicle that has a baggage space suitable for the sizes and the number of bags that the user will carry when going out somewhere as a vehicle to be dispatched.

The aforementioned sensor may include location sensors attached respectively to a plurality of bags that the user has. The location sensor mentioned here is a sensor that can determine the location of the bag to which it is attached. When packing a bag, the user is supposed to move the bag from a specific storage place to another place (e.g. a place where the user can pack the bag conveniently). Therefore, the controller may detect a bag (among the bags that the user has) that has moved from the specific storage place on the basis of information acquired by the location sensor attached to each bag and estimate that the user has packed the detected bag. In this connection, information that links the location sensors for the respective bags that the user has and the sizes of the respective bags may be stored in a storage unit of the information processing apparatus. This enables the controller to determine the size of the bag that is estimated to have been packed by the user before going out somewhere. The controller can determine the number of bags estimated to have been packed by the user before going out somewhere by counting the number of bags that have been moved from the specific storage place. Thus, the controller can forecast the sizes and the number of bags that the user will carry when going out somewhere by determining the sizes and the number of bags estimated to have been packed by the user before going out somewhere in this way.

The aforementioned sensor may include object detection sensors attached respectively to a plurality of bags that the user has. The object detection sensor refers to a sensor that can sense the number of objects stored in the bag. For example, the object detection sensor may detect objects utilizing echo location technology using ultrasonic waves or radio waves (millimeter waves). When the user packs a bag, the number of objects stored in the bag is supposed to change (e.g. increase). Therefore, the controller may determine a bag (among the bags that the user has) of which the number of stored objects has changed on the basis of information acquired by the object detection sensor and estimate that the bag thus determined has been packed by the user. In this connection, information that links the object detection sensors for the respective bags that the user has and the sizes of the respective bags may be stored in the storage unit of the information processing apparatus. This enables the controller to determine the size of the bag that is estimated to have been packed by the user before going out somewhere. The controller can determine the number of bags estimated to have been packed by the user before going out somewhere by counting the number of bags of which the number of stored objects has changed. Thus, the controller can forecast the sizes and the number of bags that the user will carry when going out somewhere by determining the sizes and the number of bags estimated to have been packed by the user before going out somewhere in this way.

The aforementioned sensor may include a camera provided in the user's home. In this case, the controller may determine the sizes and the number of bags that the user has packed by analyzing an image captured by the camera. Thus, the controller can forecast the sizes and the number of bags that the user will carry when going out somewhere by determining the sizes and the number of bags that have been packed by the user before going out somewhere in this way.

After forecasting the sizes and the number of bags that the user will carry when going out somewhere as above, the controller may send offer information to the terminal used by the user, triggered by forecasting of the sizes and the number of bags that the user will carry when going out somewhere. In the case where the user accepts the offer presented by the offer information, if the offer information is sent to the terminal immediately before the user goes out, actual dispatch of a vehicle may be late for the user's going out. If sending of the offer information to the terminal is triggered by forecasting of the sizes and the number of bags that the user will carry when going out somewhere, a dispatched vehicle is more likely to arrive in time for the user's going out, in the case where the user accepts the offer presented by the offer information.

In the case where the property of baggage defined in this disclosure includes information about the sizes and the number of bags that the user will carry when going out somewhere, the controller may forecast the sizes and the number of bags that the user will carry when going out somewhere on the basis of at least one of information about a period through which the user is scheduled to be out, information about a destination to which the user will go, and information about the gender of the user. The longer the period through which the user is scheduled to be out is, the larger the sizes and the number of bags tend to be due to increased amount of baggage, such as increased spare clothes. The lower the temperature at the destination is, the larger the sizes and the number of bags tend to be, because user will carry bulkier clothes when going to low temperature places. The sizes and the number of bags that female users carry tend to be larger than those that male users carry. Therefore, the controller can forecast the sizes and the number of bags that the user will carry when going out somewhere taking into account the above-mentioned tendencies. The controller may obtain information about the period through which the user is scheduled to be out and information about the destination from schedule information of the user. The controller may store information about the gender of the user in advance.

In the case where the controller forecasts the sizes and the number of bags that the user will carry when going out somewhere on the basis of information about at least one of the period through which the user is scheduled to be out, the destination to which the user will go, and the gender of the user, the controller may send offer information to the terminal a specific time earlier than the beginning of the period through which the user is scheduled to be out. The specific time mentioned above is a length of time equal to the time required for a dispatched vehicle to travel to the user plus a certain margin. Thus, in the case where the user accepts the offer presented by the offer information, the dispatched vehicle can arrive in time for the user's going out.

In the case where the property of baggage defined in this disclosure includes information about the sizes and the number of bags that the user will carry when going out somewhere, and the user will go out from a stay facility after checking out from it, the controller may forecast the sizes and the number of bags that the user will carry when going out somewhere on the basis of the sizes and the number of bags that the user carried at the time when he or she checked in at the stay facility. The controller may send offer information to the terminal a specific time earlier than the scheduled date and time of user's checking out from the stay facility. Thus, in the case where the user will go out from a stay facility after checking out from it, the controller can offer a vehicle provided with a baggage space suitable for the sizes and the number of bags that the user will carry as a vehicle to be dispatched.

### EMBODIMENT

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of this disclosure only to them, unless otherwise stated.

What is described in the following as an embodiment is a case where the technology disclosed herein is applied to a system that provides vehicle dispatch service to users who intend to go out somewhere from their homes. This system will also be referred to as “vehicle dispatch system” hereinafter. Vehicles dispatched by the exemplary vehicle dispatch system described in the following by way of example are vehicles for carrying passengers, such as taxis or on-demand buses, which will be collectively referred to as “taxis” in the following description. Vehicles dispatched by the vehicle dispatch service may include rented cars or shared cars.

### (General Configuration of Vehicle Dispatch System)

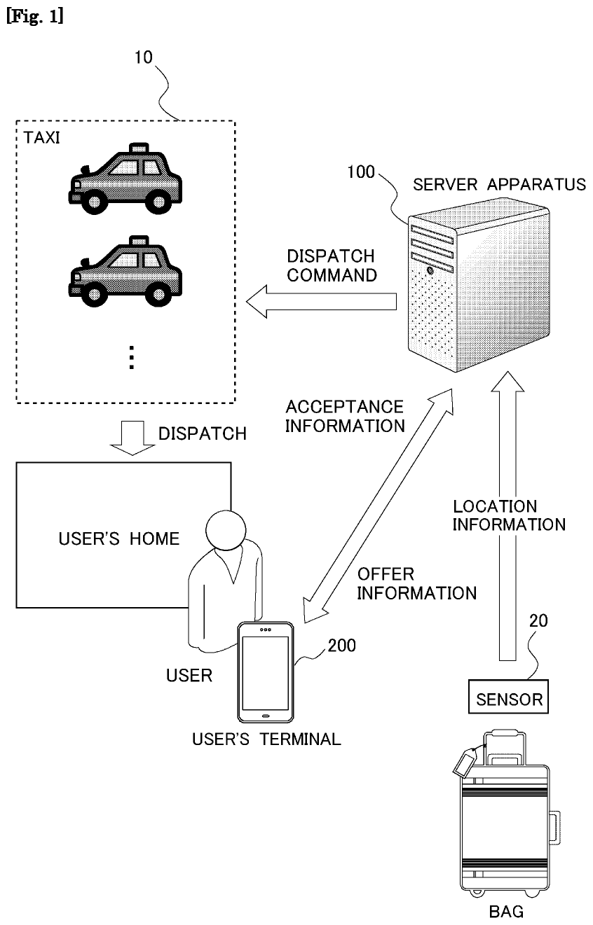

FIG. 1 is a diagram illustrating an exemplary configuration of a vehicle dispatch system that dispatches taxis to user's homes. The exemplary vehicle dispatch system illustrated in FIG. 1 includes taxis 10, a server apparatus 100, sensors 20, and a user's terminal 200.

The taxi 10 is a vehicle for carrying passengers. The server apparatus 100 is an information processing apparatus for managing dispatch of taxis 10. The sensor 20 is a device used in the process of forecasting the sizes and the numbers of bags that a user will carry when going out somewhere from his/her home. The sensors 20 used in the system of this embodiment are sensors that are attached respectively to bags that the user has and capable of determining the present locations of the respective bags. Each sensor 20 has the function of determining the present location of itself (i.e. the present location of the bag to which it is attached) and sending information about the determined present location to the server apparatus 100, which will also be referred to as “location information”. The sensor 20 may execute the processing of determining the present location and sending the location information either repeatedly at predetermined intervals or in response to a request sent from the server apparatus 100. The user's terminal 200 is a terminal carried by the user, which is capable of communicating with the server apparatus 100. Alternatively, the user's terminal 200 may be a stationary terminal set in the user's home or other places.

The server apparatus 100 in the vehicle dispatch system forecasts the sizes and the number of bags that the user will carry when going out somewhere from the user's home. The server apparatus 100 according to this embodiment forecasts the sizes and the number of bags that the user will carry when going out somewhere from the user's home by determining the sizes and the number of bags that the user has packed on the basis of information acquired by the sensors 20. After forecasting the sizes and the number of bags that the user will carry when going out somewhere from the user's home, the server apparatus 100 sends information for offering dispatch of a taxi 10 capable of carrying the forecast sizes and number of bags to the user's terminal 200. This information will also be referred to as “offer information” hereinafter. If the user's terminal 200 sends information (or acceptance information) indicating acceptance of the offer presented by the offer information (i.e. acceptance of dispatch of a taxi 10) to the server 100 in replay to the offer information, the server apparatus 100 sends a dispatch command to a taxi 10 capable of carrying the forecast sizes and number of bags. Thus the vehicle dispatch system can dispatch a type of taxi 10 that is suitable for the property of the baggage while saving the user the effort of providing information about the property of the baggage (i.e. the sizes and the number of bags). Moreover, the vehicle dispatch system can prevent situations in which a taxi 10 that is not suitable for the property of the baggage from being dispatched due to the absence of appropriate information provided by the user.

### (Configuration of Vehicle Dispatch System)

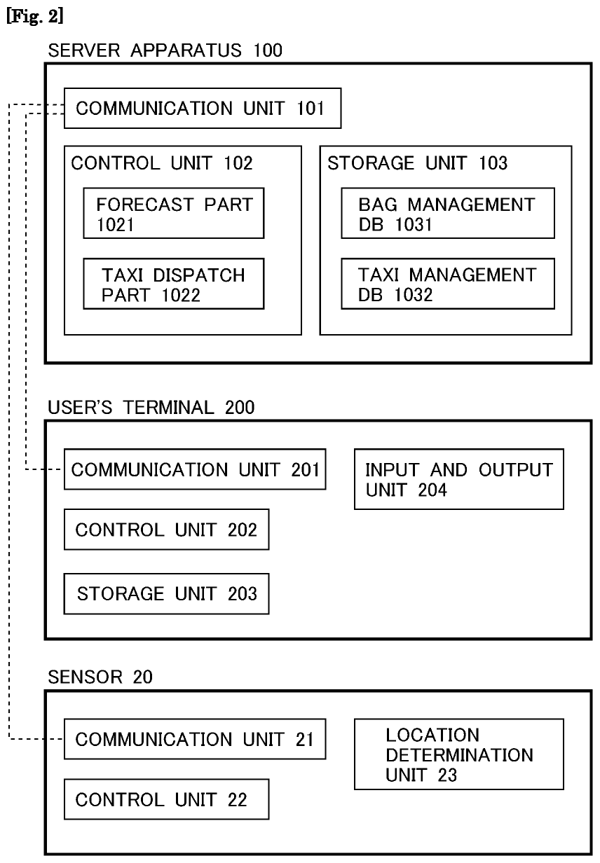

FIG. 2 is a block diagram illustrating exemplary configurations of the server apparatus 100, the user's terminal 200, and the sensor 20 included in the vehicle dispatch system.

(Server Apparatus 100)

The server apparatus 100 is an apparatus that manages dispatch of taxis 10. The server apparatus 100 constitutes the information processing apparatus according to this disclosure. The server apparatus 100 may be constituted by a general-purpose computer. For example, the server apparatus 100 includes a processor, such as a CPU or a GPU, a main storage device, such as a RAM or a ROM, and an auxiliary storage device, such as an EPROM, a hard disk drive, or a removable medium. The removable medium may be a recording medium, such as a USB memory, a CD, or a DVD. The auxiliary storage device stores an operating system (OS), programs, and tables. The programs stored in the auxiliary storage device include a program for managing dispatch of taxis to users who intend to go out somewhere from their homes. The server apparatus 100 implements functions for achieving purposes that will be described later by executing a program(s) stored in the auxiliary storage device by the processor. Some or all of the functions of the server apparatus 100 may be implemented by a hardware circuit(s), such as an ASIC or an FPGA.

As illustrated in FIG. 2, the server apparatus 100 of this embodiment has a communication unit 101, a control unit 102, and a storage unit 103. The configuration of the server apparatus 100 is not limited to the configuration illustrated in FIG. 2, but some components may be eliminated, added, or replaced by other components fitly.

The communication unit 101 is a device that connects the server apparatus 100 to a network. For example, the communication unit 101 includes a communication interface for communication with external apparatuses via the network using a communication network, such as LAN (Local Area Network), WAN (Wide Area Network), or Wi-Fi (registered trademark). The communication unit 101 may be configured to communicate with external apparatuses using a mobile communication service, such as 5G (5th Generation) mobile communications, or LTE (Long Term Evolution) mobile communications, or a wireless communication network, such as Wi-Fi.

The control unit 102 is constituted by a processor, such as a CPU, and performs overall control of the server apparatus 100. The control unit 102 of this embodiment has, as functional modules, a forecast part 1021 and a taxi dispatch part 1022. The control unit 102 implements these functional modules by executing a program stored in the auxiliary storage device by the processor.

The forecast part 1021 forecasts the sizes and the number of bags that a user will carry when going out somewhere from his/her home. In this process of forecasting, the forecast part 1021 communicates with the sensors 20 through the communication unit 101. For example, the forecast part 1021 monitors the present locations of the respective bags on the basis of location information sent from the sensors 20 at predetermined intervals to find a bag that has been moved from a storage place in the user's home to another place in the user's home. The forecast part 1021 estimates that the user has packed the bag that has been moved from the storage place to another place in the user's home. This is because if the user packs a bag with baggage, the user is supposed to move the bag to be packed with baggage from the storage place in the user's home to another place in the user's home, namely a place where the user can pack the bag conveniently. After finding a bag that is estimated to have been packed by the user, the forecast part 1021 determines the size of the bag. The size of the bag that is estimated to have been packed by the user is determined based on data (bag management database 1031) stored in the storage unit 103, which will be specifically described later.

The number of bags that the user has moved from the storage place in the user's home is not always one. There may be cases where the number of bags that the user will carry when going out somewhere from the user's home is more than one. In such cases, the forecast part 1021 may execute the processing of determining the size of the bag for each of the bags that have been moved from the storage place. Moreover, the forecast part 1021 forecasts the number of bags that the user will carry when going out somewhere by counting the number of bags that have been moved from the storage place.

Information about the sizes and the number of bags forecast by the above process is passed from the forecast part 1021 to the taxi dispatch part 1022.

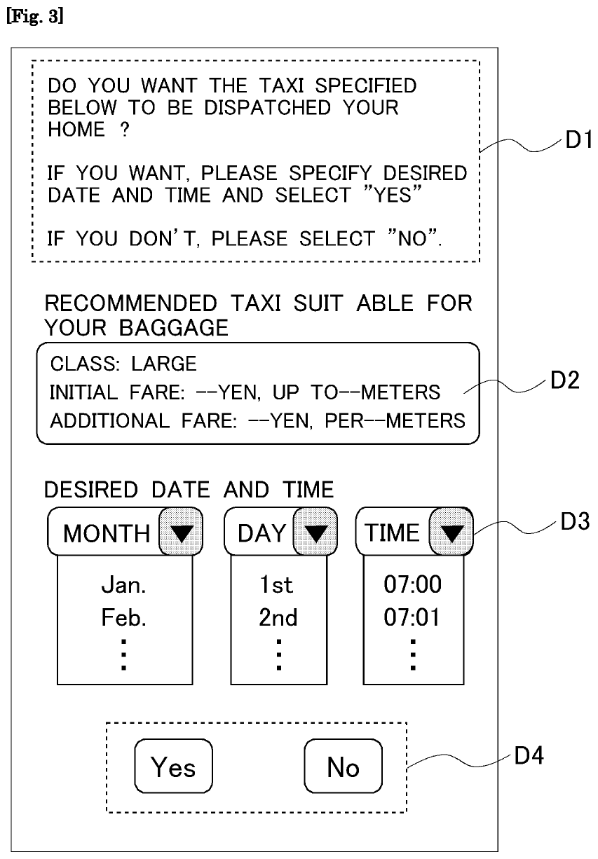

The taxi dispatch part 1022 has the function of generating offer information and the function of dispatching a taxi 10. Specifically, the taxi dispatch part 1022 generates offer information based on information passed from the forecast part 1021. The offer information is information for offering dispatch of a type of taxi 10 that is suitable for the sizes and the number of bags that the user will carry when going out somewhere to the user's home. For example, the offer information includes information for causing the user's terminal 200 to display a screen shown in FIG. 3. As shown in FIG. 3, the offer information may include information for causing the user's terminal 200 to display a message asking whether the user wants dispatch of a taxi 10 (D1 in FIG. 3), information indicating a type (or class) of taxis 10 suitable for the sizes and the number of bags that the user will carry and its fare (D2 in FIG. 3), a menu allowing the user to designate a desired date and time of arrival of a dispatched taxi 10 (D3 in FIG. 3), and buttons allowing the user to select acceptance or declination of the offer presented by the offer information (D4 in FIG. 3). The offer information may contain information about the sizes and the number of bags forecast by the forecast part 1021. This allows the user to check whether the sizes and the number of bags forecast by the server apparatus 100 is correct. The offer information is sent from the taxi dispatch part 1022 to the user's terminal 200 through the communication unit 101.

If the user sees the screen shown in FIG. 3 and conducts the operation of designating a desired date and time of arrival of a dispatched taxi 10 and selecting “Yes” on the screen, the user's terminal 200 sends acceptance information to the server apparatus 100. The acceptance information is information indicating the user's acceptance of the offer presented by the offer information (i.e. dispatch of a taxi 10 to the user's home) and contains information about the desired date and time of arrival of a dispatched taxi 10 that the user has designated on the screen shown in FIG. 3. If the user sees the screen shown in FIG. 3 and conducts the operation of selecting “No”, the user's terminal 200 does not send acceptance information to the server apparatus 100. If the communication unit 101 of the server apparatus 100 receives the acceptance information, the taxi dispatch part 1022 selects a taxi 10 of the type offered in the offer information among the taxis 10 that will be empty at the desired date and time of arrival of a dispatched taxi 10 designated by the user. Then, the taxi dispatch part 1022 sends a dispatch command to the taxi 10 thus selected. The dispatch command is a command that causes the taxi 10 to go to the user's home to pick up the user at the desired date and time designated by the user.

While the user is out or away from the user's home, the bags that the user carries while the user is out have been moved from the storage place. If the forecast part 1021 and the taxi dispatch part 1022 execute the above-described processing while the user is not at home, there is a possibility that unnecessary offer may be made to the user. To avoid this, the forecast part 1021 and the taxi dispatch part 1022 execute the above-described processing on condition that the user is at home. Whether or not the user is at home can be determined, for example, using information acquired by a motion sensor set at the user's home or an image captured by a camera set in the user's home.

The storage unit 103 is constituted by the main storage device and/or the auxiliary storage device. The storage unit 103 stores various information. Specifically, the storage unit 103 stores various programs executed by the processor and various data. In the storage unit 103 of this embodiment is constructed a bag management database 1031 and a taxi management database 1032. The bag management database 1031 and the taxi management database 1032 are constructed by managing data stored in the auxiliary storage device by a database management system program (DBMS program) executed by the processor. The bag management database 1031 and the taxi management database 1032 may be relational databases.

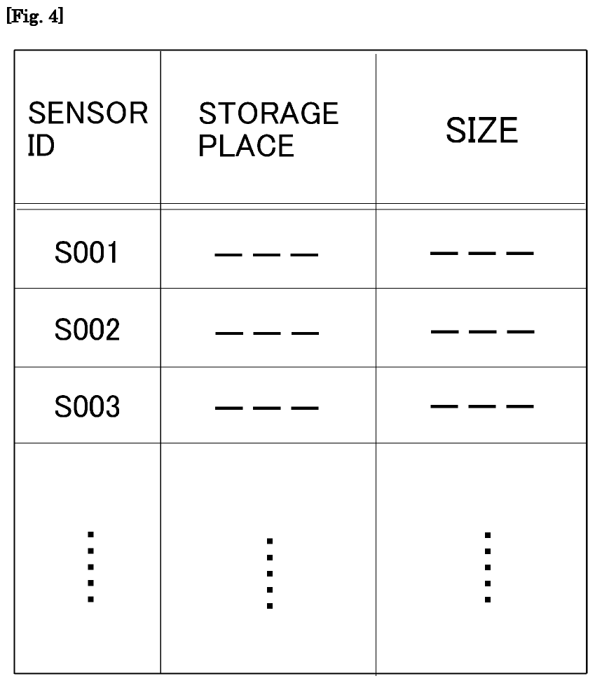

What is stored in the bag management database 1031 is information about properties of bags that the user has. The bag management database 1031 links properties of the bags that the user has and the sensors 20. An exemplary structure of information stored in the bag management database 1031 will be described here with reference to FIG. 4. FIG. 4 illustrates an exemplary table structure of information stored in the bag management database 1031. The structure of tables stored in the bag management database 1031 (which will also be referred to as “bag information tables” hereinafter) is not limited to that illustrated in FIG. 4, but some fields may be added, changed, or removed.

In the example illustrated in FIG. 4, bag information tables are created for the respective bags that the user has. In other words, bag information tables as many as the bags that the user has are stored in the bag management database 1031. Each bag information table has the fields of sensor ID, storage place, and size. What is stored in the sensor ID field is information for identifying each sensor 20 (i.e. sensor ID) attached to each of the bags that the user has. The sensor ID is information for distinguishing each sensor 20 attached to a bag from sensors 20 attached to other bags. What is stored in the storage place field is information indicating the place where the bag to which each sensor 20 is attached is stored. The storage place refers to a place in the user's home where each bag is stored, which may vary among the bags. What is stored in the size field is information indicating the size of the bag to which each sensor 20 is attached. The information stored in the size field may be either information specifying the dimensions of the bag or a classified size (e.g. large size, medium size, or small size etc.) of the bag.

The storage unit 103 in which the bag management database 1031 is stored constitutes the “storage unit” defined in this disclosure.

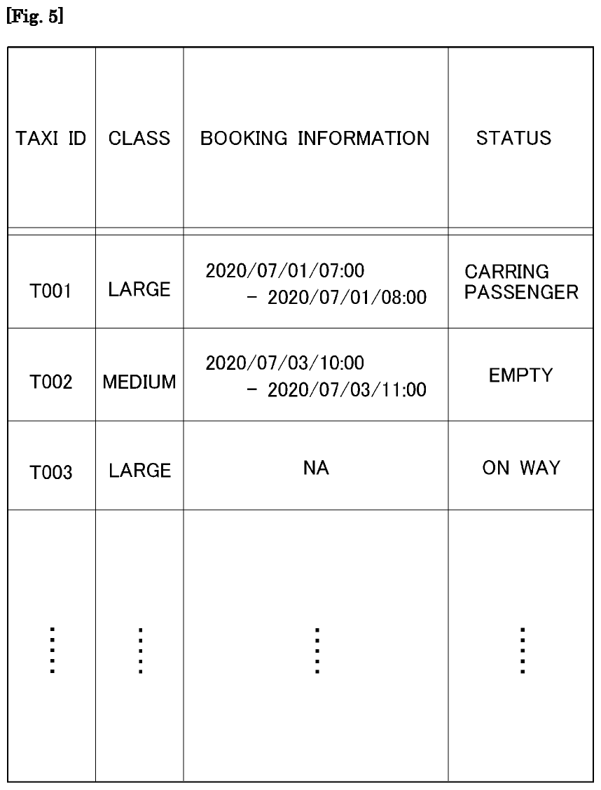

What is stored in the taxi management database 1032 is information relating to the taxis 10 that are under the management of the server apparatus 100. The taxis management database 1032 links properties of each taxi 10 and its operation state. An exemplary structure of information stored in the taxi management database 1032 will be described here with reference to FIG. 5. FIG. 5 illustrates an exemplary table structure of information stored in the taxi management database 1032. The structure of tables stored in the taxi management database 1032 (which will also be referred to as “taxi information tables” hereinafter) is not limited to that illustrated in FIG. 5, but some fields may be added, changed, or removed.

In the example illustrated in FIG. 5, taxi information tables are created for the respective taxis 10 that are under the management of the server apparatus 100. In other words, taxi information tables as many as the taxis 10 that are under the management of the server apparatus 100 are stored in the taxi management database 1032. Each taxi information table has the fields of taxi ID, class, booking information, and status. What is stored in the taxi ID field is information (or taxi ID) for identifying each of the taxis 10 that are under the management of the server apparatus 100. The taxis 10 are classified into a plurality of classes according to the sizes of their baggage spaces, and what is stored in the class field is information indicating the class (or type) of each taxi 10. For example, in the case of taxis 10 whose baggage space is relatively large, the information “large” is stored in the class field. In the case of taxis 10 whose baggage space is relatively small, the information “medium” is stored in the class field. What is stored in the booking field is information relating to booking for dispatch of each taxi 10. For example, in the case of taxis 10 that are booked for dispatch, information specifying the date and time of the beginning and the end of the booked period is stored in the booking field. In the case of taxis 10 that are not booked for dispatch, the information “NA” is stored in the booking field. What is stored in the status field is information indicating the status of each taxi 10. For example, in the case of taxis 10 that are carrying a passenger(s), the information “carrying passengers” is stored in the status field. In the case of taxis that are on their way to pick up a passenger(s), the information “on way” is stored in the status field. In the case of empty taxis, the information “empty” is stored in the status field.

Various processing executed by the server apparatus 100 configured as above may be executed by either hardware or software. The configuration of the server apparatus 100 is not limited to the configuration illustrated in FIG. 2, but some components may be eliminated, added, or replaced by other components.

(User' Terminal 200)

The user's terminal 200 is a small computer carried by the user. The user's terminal 200 may be, for example, a smartphone, a cellular phone, a tablet terminal, or a wearable computer (e.g. a smartwatch).

As illustrated in FIG. 2, the user's terminal 200 has a communication unit 201, a control unit 202, a storage unit 203, and an input and output unit 204. The configuration of the user's terminal 200 is not limited to the configuration illustrated in FIG. 2, but some components may be eliminated, added, or replaced by other components.

The communication unit 201 is a wireless communication interface for connecting the user's terminal 200 to a network. The communication unit 201 is connected to a network using a mobile communication service, such as 5G (5th Generation) mobile communications, or LTE (Long Term Evolution) mobile communications, or a wireless communication network, such as Wi-Fi (registered trademark) and communicates with the server apparatus 100 through the network.

The control unit 202 is constituted by, for example, a microcomputer and performs overall control of the user's terminal 200. For example, when the communication unit 201 receives offer information sent from the server apparatus 100, the control unit 202 causes the input and output unit 204 (which will be specifically described later) to display the aforementioned screen shown in FIG. 3. When the user designates a desired date and time of arrival of a dispatched taxi 10 and selects “Yes” on the screen shown in FIG. 3, the control unit 202 generates acceptance information containing information about the desired date and time of arrival of a dispatched taxi 10. Moreover, the control unit 202 sends the acceptance information thus generated to the server apparatus 100 through the communication unit.

The storage unit 203 stores various information. The storage unit 203 may be constituted by a storage medium, such as a RAM, a magnetic disk, or a flash memory. The storage unit 203 stores various programs executed by the control unit 202 and various data.

The input and output unit 204 is configured to receive inputting operations conducted by the user and present information to the user. The input and output unit 204 includes, for example, a touch panel, a control circuit for the touch panel, a liquid crystal display, a control circuit for the liquid crystal display, a microphone, a control circuit for the microphone, a speaker, and a control circuit for the speaker. The touch panel and the liquid crystal display may be constituted by a single touch panel display. When the user's terminal 200 receives the offer information sent from the server apparatus 100, the input and output unit 204 according to this embodiment outputs the screen shown in FIG. 3 on the touch panel display. When the user selects “Yes” or “No” in the screen shown in FIG. 3 displayed on the touch panel display, the input and output unit 204 passes information about the result of selection to the control unit 202. In the case where “Yes” is selected by the user, the input and output unit 204 also passes information about the desired date and time designated by the user on the screen shown in FIG. 3 displayed on the touch panel display to the control unit 202.

Various processing executed by the user's terminal 200 configured as above may be executed by either hardware or software.

(Sensor 20)

The sensor 20 is a small device attached to each of a plurality of bags that the user has. The sensor 20 has the function of determining the present location of the bag and sending information about the present location to the server apparatus 100.

As illustrated in FIG. 2, the sensor 20 has a communication unit 21, a control unit 22, and a location determination unit 23. The configuration of the sensor 20 is not limited to the configuration illustrated in FIG. 2, but some components may be eliminated, added, or replaced by other components.

The communication unit 21 and the control unit 22 of the sensor 20 are similar to the communication unit 201 and the control unit 202 of the user's terminal 200 and will not be described further. The location determination unit 23 is a device capable of determining the present location of the bag to which the sensor 20 is attached and constitutes the “location sensor” defined in this disclosure. The location determination unit 23 typically includes a GPS (Global Positioning System) receiver. Information about the present location determined by the location determination unit 23 is sent through the communication unit 21 to the server apparatus 100 together with the sensor ID of the sensor 20. In other words, information specifying the present location of the bag and the sensor ID is sent from the sensor 20 to the server apparatus 100 as the aforementioned location information.

Various processing executed by the sensor 20 configured as above may be executed by either hardware or software.

### (Process Performed by Server Apparatus)

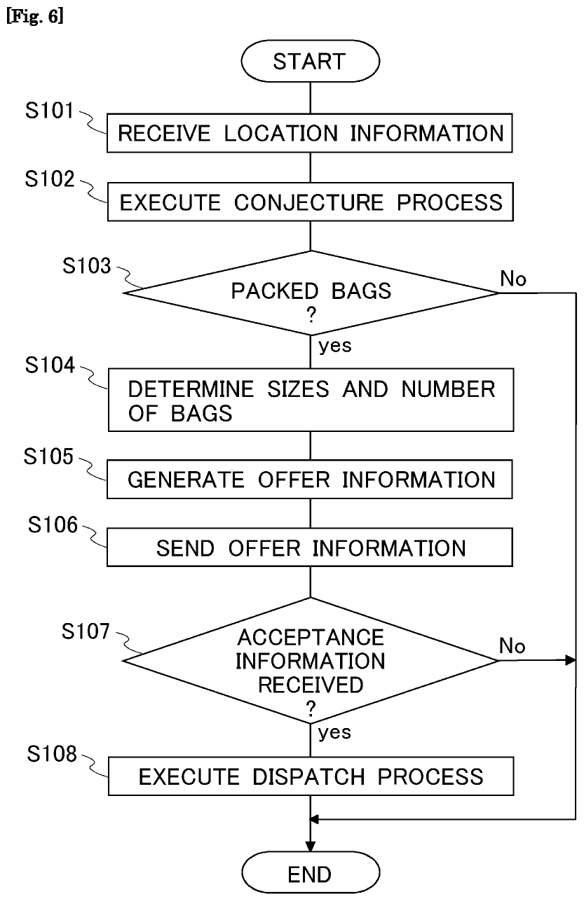

A process performed by the server apparatus 100 according to this disclosure will now be described with reference to FIG. 6. FIG. 6 is a flow chart of a process executed by the server apparatus 100, which is triggered by reception of location information from the sensors 20. The process according to the flow chart of FIG. 6 is executed on condition that the user is at the user's home, as described previously.

In the process according to the flow chart of FIG. 6, the communication unit 101 of the server apparatus 100 receives location information sent from sensors 20 (step S101). The location information received by the communication unit 101 is passed to the control unit 102.

Then, the forecast part 1021 of the control unit 102 executes an estimation process based on the location information (step S102). Specifically, as described previously, the forecast part 1021 finds a bag that has been moved from a storage place in the user's home to another place on the basis of the location information. More specifically, the forecast part 1021 accesses the bag management database 1031 using the sensor ID contained in the location information as an argument to find a bag information table in which the ID same as this sensor ID is stored in its sensor ID field. Then, the forecast part 1021 compares the information stored in the storage place field of the bag information table found as above and the present location specified by the location information to estimate whether packing of the bag to which this sensor 20 is attached has been done by the user. In this process, if the present location of the bag to which this sensor 20 is attached is away from the storage place more than a predetermined distance (e.g. several tens of centimeters to several meters), the forecast part 1021 estimates that packing of the bag has been done by the user. If the distance between the present location of the bag to which this sensor 20 is attached and the storage place is smaller than the aforementioned predetermined distance, the forecast part 1021 estimates that packing of the bag has not been done by the user. The above estimation process is executed for every location information received by the server apparatus 100. In other words, the above estimation process is executed for all the bags that the user has (i.e. all the bags to which the sensors 20 are attached).

After executing the above estimation process for all of the bags that the user has, the forecast part 1021 determines whether there is a bag that has been packed by the user among the bags that the user has (step S103). If it is determined that there is no bag that has been packed by the user among the bags that the user has (a negative answer in step S103), the process according to the flow chart of FIG. 6 is ended. If it is determined that there is a bag that has been packed by the user among the bags that the user has (an affirmative answer in step S103), the processing of step S104 is executed next.

In step S104, the forecast part 1021 determines the sizes and the number of bags estimated to have been packed by the user. Specifically, the forecast part 1021 accesses the bag management database 1031 on the basis of the sensor ID of the sensor 20 attached to the bag estimated to have been packed by the user. The forecast part 1021 finds the bag information table in which the sensor ID same as the sensor ID of this sensor 20 is stored in its sensor ID field. Then, the forecast part 1021 retrieves the information stored in the size field of the bag information table thus found. Thus, the size of the bag estimated to have been packed by the user is determined. Moreover, the forecast part 1021 counts the number of bags estimated to have been packed by the user. Thus, the number of bags estimated to have been packed by the user is determined. Information about the sizes and the number of bags determined in step S104 is passed to the forecast part 1021 to the taxi dispatch part 1022.

The taxi dispatch part 1022 generates offer information based on the information passed from the forecast part 1021 (step S105). As described previously, the offer information is information for offering dispatch of a type of taxi suitable for the sizes and the number of bags that the user will carry when going out somewhere to the user's home. The offer information includes information for causing the user's terminal 200 to output (or display) a screen like that shown in FIG. 3. In the process of generating the offer information, the taxi dispatch part 1022 determines the class of the taxi 10 that can carry all of bags that the user will carry when going out somewhere on the basis of the sizes and the number of the bags. If the sizes or the number of bags that the user will carry when going out somewhere is relatively large, the taxi dispatch part 1022 determines the class of the taxi 10 as the large class. If the sizes or the number of bags that the user will carry when going out somewhere is relatively small, the taxi dispatch part 1022 determines the class of the taxi 10 as the medium class. After determining the class of the taxi 10 in this way, the taxi dispatch part 1022 generates offer information that is configured to present the class determined as above and a fare (initial fare and additional fare) adapted to this class in the area D2 in FIG. 3.

The taxi dispatch part 1022 sends the offer information generated as above to the user's terminal 200 through the communication unit 101 (step S106). Then, in the user's terminal 200, the control unit 202 causes the input and output unit 204 to output (or display) a screen like that shown in FIG. 3. If the user designates a desired date and time of arrival of a dispatched taxi 10 and selects “yes” on the screen shown in FIG. 3, the control unit 202 generates acceptance information containing information about the desired date and time of arrival of a dispatched taxi 10. The control unit 202 sends the acceptance information thus generated to the server apparatus 100 through the communication unit 201. In the case where the user selects “No” on the screen shown in FIG. 3, the control unit 202 does not generate acceptance information, and acceptance information is not sent from the user's terminal 200 to the server apparatus 100.

In step S107, the taxi dispatch part 1022 determines whether the communication part 101 has received acceptance information sent from the user's terminal 200. Even in the case where the user intends to accept the offer presented by the offer information, acceptance information is not always sent immediately in response to the offer information. In step S107, therefore, the taxi dispatch part 1022 may determine whether the communication unit 101 has received acceptance information from the user's terminal 200 within a predetermined time (e.g. several to several tens of minutes) after sending the offer information. If the communication unit 101 has not received acceptance information from the user's terminal 200 within the predetermined time after sending the offer information (a negative answer in step S107), the process according to the flow chart of FIG. 6 is ended. If the communication unit 101 has received acceptance information from the user's terminal 200 within the predetermined time after sending the offer information (an affirmative answer in step S107), the processing of step S108 is executed next.

In step S108, the taxi dispatch part 1022 executes a dispatch process. Specifically, the taxi dispatch part 1022 accesses the taxi management database 1032 to select taxis 10 that are empty and do not have a booking at the desired date and time of arrival designated by the user. Then, the taxi dispatch part 1022 chooses a taxi 10 of the class determined in step S105 from among the selected taxis 10 as the taxi 10 to be dispatched. Then, the taxi dispatch part 1022 sends a dispatch command to the taxi 10 thus chosen. As described above, the dispatch command is a command to cause the taxi 10 to go to the user's home to pick up the user at the desired date and time of arrival. The taxi dispatch part 1022 accesses the taxi information table associated with the taxi 10 to be dispatched to update the information stored in the booking information field thereof according to the desired date and time of arrival designated by the user.

The vehicle dispatch system of this embodiment can dispatch a type of taxi 10 that is suitable for the property of baggage of a user who wants dispatch of a taxi 10 when going out somewhere, while saving the user the effort of providing (or sending) information about the property of the baggage (e.g. the sizes and the number of bags). Moreover, the vehicle dispatch system of this embodiment can prevent situations in which a taxi 10 that is not suitable for the property of the baggage is dispatched to the user due to the absence of appropriate information provided by the user. Therefore, the vehicle dispatch system of this embodiment can dispatch taxis 10 efficiently to users who intend to go out somewhere from their homes.

### <First Modification>

The system described in the foregoing as an embodiment uses a sensor 20 having a location determination unit 23 capable of determining the present location of a bag. In the following, a first modification of the system according to the embodiment will be described, which uses a sensor having an object detection unit capable of detecting objects stored in a bag. This object detection unit constitutes the “object detection sensor” defined in this disclosure.

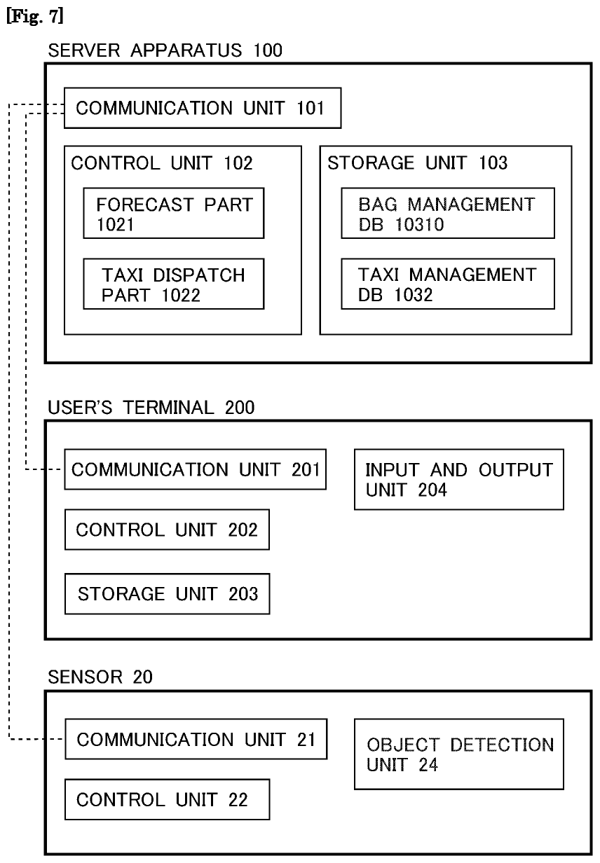

FIG. 7 is a block diagram illustrating exemplary configurations of a server apparatus 100, a user's terminal 200, and a sensor 20 included in a vehicle dispatch system according to the first modification. In FIG. 7, components similar to those in the above-described embodiment are denoted by the same reference signs as in FIG. 2.

As illustrated in FIG. 7, the sensor 20 according to the first modification has an object detection unit 24 instead of the location determination unit 23 in the above-described embodiment. The object detection unit 24 is configured to detect the number of objects stored in a bag utilizing, for example, echo location using ultrasonic waves or radio waves (millimeter waves). In this connection, the control unit 22 of the sensor 20 has the function of sending information specifying the number of objects stored in the bag and the sensor ID to the server apparatus 100 through the communication unit 21 at predetermined intervals. This information will also be referred to as “storage information” hereinafter.

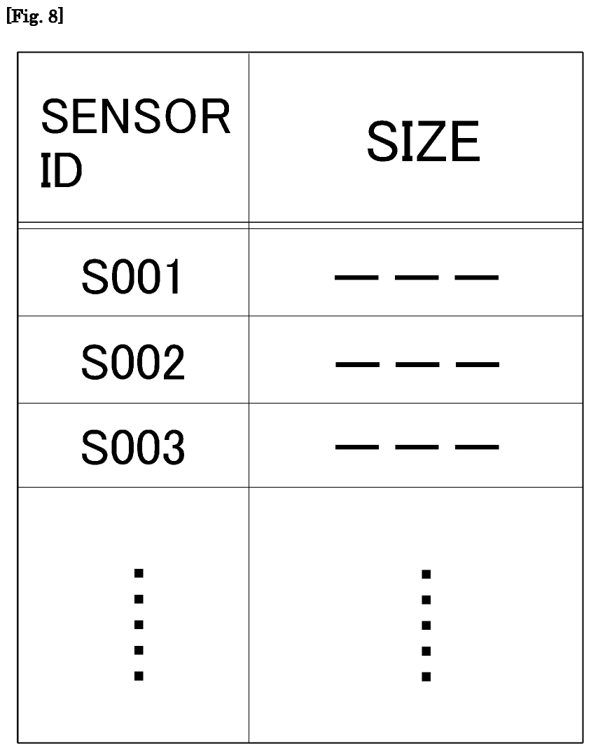

In the storage unit 103 of the server apparatus 100 according to the first modification is constructed a bag management database 10310 different from the bag management database 1031 in the above-described embodiment. What is stored in the bag management database 10310 is bag information tables illustrated in FIG. 8. The bag information table of the system according to the first modification has the fields of sensor ID and size but does not have the storage place field. Information stored in the sensor ID field and information stored in the size field are the same as those in the above-described embodiment illustrated in FIG. 4.

The forecast part 1021 according to this modification monitors the number of objects stored in each bag on the basis of storage information sent from the sensors 20 at predetermined intervals to find a bag of which the number of stored objects has changed. The forecast part 1021 estimates that the user has packed the bag of which the number of stored objects has changed. This is because if the user packs a bag, the number of objects stored therein is supposed to change. After finding the bag estimated to have packed by the user, the forecast part 1021 determines the size of the bag. The processing of determining the size of the bag is executed based on information stored in the bag management database 1031 in the same manner as in the above-described embodiment. Moreover, the forecast part 1021 forecasts the number of bags that the user will carry when going out somewhere by counting the number of bags of which the number of stored objects has changed among the bags that the user has.

The features and functions of the system according to the first modification other than the bag management database 10310, the forecast part 1021, and the sensor 20 are the same as those in the system according to the above-described embodiment. Therefore, the taxi dispatch part 1022 in the system according to the first modification may execute the processing of generating offer information and the processing of dispatching a taxi on the basis of the sizes and the number of bags forecast by the forecast part 1021 in the same manner as the system according to the above-described embodiment.

The system according to the first modification can determine the sizes and the number of bags that are estimated to have been packed by the user on the basis of the number of objects stored in each of the bags that the user has. Therefore, this system can achieve the advantageous effects same as the system according to the above-described embodiment.

### <Second Modification>

The system described in the foregoing as an embodiment uses a sensor 20 having a location determination unit 23 capable of determining the present location of a bag. In the following, a second modification of the system according to the embodiment will be described, which uses a sensor having an image capturing unit capable of capturing images in the user's home. This image capturing unit constitutes the “camera” defined in this disclosure.

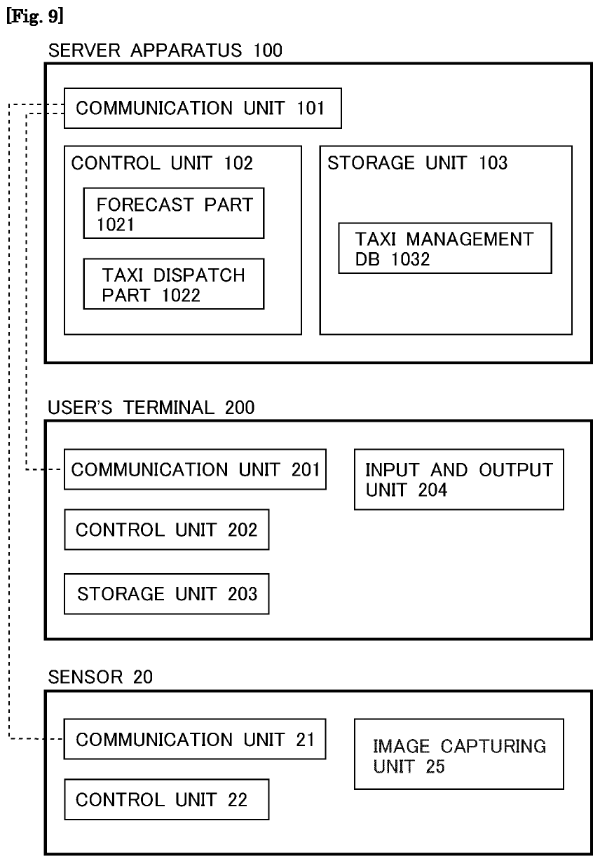

FIG. 9 is a block diagram illustrating exemplary configurations of a server apparatus 100, a user's terminal 200, and a sensor 20 included in a vehicle dispatch system according to the second modification. In FIG. 9, components similar to those in the above-described embodiment are denoted by the same reference signs as in FIG. 2.

As illustrated in FIG. 9, the sensor 20 according to the second modification has an image capturing unit 25 instead of the location determination unit 23 in the above-described embodiment. The image capturing unit 25 is a device capable of capturing images in the user's home, which specifically is a camera capable of capturing moving or still images. In this case, the sensors 20 are not attached to bags that the user has but set in the user's home. The sensors 20 may be set at a plurality of places (e.g. respective rooms) in the user's home or only in a room where the user packs bags. The control unit 22 of the sensor 20 according to the second modification has the function of sending information including an image(s) captured by the image capturing unit 25 to the server apparatus 100 through the communication unit 21 at predetermined intervals. This information will also be referred to as “image information” hereinafter.

The forecast part 1021 according to the second modification estimates the sizes and the number of bags that the user has packed on the basis of image information sent from the sensors 20 at predetermined intervals. In this process, the forecast part 1021 may determine the sizes and the number of bags that the user has packed by analyzing an image(s) captured by the image capturing unit 25. The forecast part 1021 may read an item tag of a bag that the user has packed from an image(s) captured by the image capturing unit 25 and determine the size of the bag on the basis of the item tag thus read.

Since the system according to the second modification forecasts the sizes and the number of bags that the user will carry when going out somewhere in the above-described way, the bag management database 1031 described in the above embodiment is not constructed in the storage unit 103 of the server apparatus 100.

The features and functions of the system according to the second modification other than the storage unit 103, the forecast part 1021, and the sensor 20 are the same as those in the system according to the above-described embodiment. Therefore, the taxi dispatch part 1022 in the system according to the second modification may execute the processing of generating offer information and the processing of dispatching a taxi on the basis of the sizes and the number of bags forecast by the forecast part 1021 in the same manner as the system according to the above-described embodiment.

The system according to the second modification can determine the sizes and the number of bags packed by the user on the basis of an image(s) captured by the image capturing unit 25 of the sensor 20. Therefore, this system can achieve the advantageous effects same as the system according to the above-described embodiment.

<Third Modification>

The systems described in the foregoing as the embodiment and the first and second modifications use a sensor 20 to forecast the sizes and the number of bags that the user will carry when going out somewhere. In the following, a third modification of the system according to the embodiment will be described, which is configured to forecast the sizes and the number of bags that the user will carry when going out somewhere on the basis of a period through which the user is scheduled to be out, a destination to which the user will go, and the gender of the user.

The longer the period through which the user is scheduled to be out is, the larger the sizes and the number of bags tend to be due to increased amount of baggage, such as increased spare clothes. The lower the temperature at the destination is, the larger the sizes and the number of bags tend to be, because user will carry bulkier clothes when going to low temperature places. The sizes and the number of bags that female users carry tend to be larger than those that male users carry.

In view of the above tendencies, the longer the period through which the user is scheduled to be out is, the larger the forecast part 1021 in the system according to the third modification forecasts the sizes and the number of bags that the user will carry when going out somewhere. The lower the temperature at the destination is, the larger the forecast part 1021 in the system according to the third modification forecasts the sizes and the number of bags that the user will carry when going out somewhere. The forecast part 1021 in the system according to the third modification forecasts the sizes and the number of bags that the user will carry when going out somewhere larger for female users than for male users. Information about the period through which the user is scheduled to be out and information about the destination to which the user will go may be obtained from schedule information of the user. In this connection, if a schedule management application program is installed in the user's terminal 200, the forecast part 1021 may obtain schedule information of the user by communicating with the user's terminal 200 through the communication unit 101.

The taxi dispatch part 1022 in the system according to the third modification may send offer information to the user's terminal 200 a specific time earlier than the beginning of the period through which the user is scheduled to be out. The specific time mentioned above is a length of time equal to the time required for a dispatched taxi to travel to the user plus a certain margin. Thus, in the case where the user accepts the offer presented by the offer information, the dispatched vehicle can arrive in time for the user's going out.

The system according to the third modification can forecast the sizes and the number of bags that the user will carry when going out somewhere, even in cases where sensors 20 are not attached to bags that the user has or set in the user's home. Therefore, this system can achieve the advantageous effects same as the systems according to the above-described embodiment and the first and second modifications, even in cases where sensors 20 are not attached to bags that the user has or set in the user's home.

### <Fourth Modification>

The systems described in the foregoing as the embodiment and the first to third modifications forecast the sizes and the number of bags that the user will carry when going out somewhere from the user's home and offer dispatch of a taxi 10 to the user. In the following, a fourth modification of the system according to the embodiment will be described, which forecasts the sizes and the number of bags that the user will carry when leaving a stay facility after checking out from it and offers dispatch of a taxi 10 to the user.

The forecast part 1021 according to the fourth modification forecasts the sizes and the number of bags that a user will carry when going out from (or leaving) a stay facility after checking out from it on the basis of the sizes and the number of bags that the user carried at the time when he or she checked in at the stay facility. In this process, the forecast part 1021 may forecast the sizes and the number of bags that the user will carry when going out from the stay facility after checking out from it equal to the sizes and the number of bags that the user carried when he or she checked in at the stay facility. The user may have purchased something, such as souvenirs during his/her stay in the stay facility. If this is the case, the sizes and the number of bags that the user will carry when going out from the stay facility after checking out from it is expected to be larger than the sizes and the number of bags that the user carried when he or she checked in at the stay facility. Therefore, the forecast part 1021 in the system according to the fourth modification forecasts the sizes and the number of bags that the user will carry when going out from the stay facility after checking out from it larger than the sizes and the number of bags that the user carried when he or she checked in at the stay facility. For example, the forecast part 1021 may forecast the sizes and the number of bags that the user will carry when going out from the stay facility after checking out from it by taking into account the average sizes and the average number of souvenirs that guests who stayed in this stay facility in the past purchased as well as the sizes and the number of bags that the user carried when he or she checked in at the stay facility.

The sizes and the number of bags that the user carried when he or she checked in at the stay facility may be determined by analyzing an image captured by a camera set in the stay facility.

The taxi dispatch part 1022 in the system according to the fourth modification may send offer information to the user's terminal 200 a specific time earlier than the time at which the user checks out from the stay facility. The specific time mentioned above is a length of time equal to the time required for a dispatched taxi to travel to the user plus a certain margin. Thus, in the case where the user accepts the offer presented by the offer information, the dispatched vehicle can arrive in time for the user's going out.

The system according to the fourth modification can forecast the sizes and the number of bags that the user will carry when going out somewhere in cases where the user leaves a stay facility after checking out from it. Therefore, this system can achieve the advantageous effects same as the systems according to the above-described embodiment and the first and second modifications even in cases where the user leaves a stay facility after checking out from it.

### <Others>

The above embodiment and modifications have been described only by way of example. Modifications can be made to them without departing from the essence of this disclosure. For example, the class of a taxi 10 offered by the system may be determined taking into account a property of the baggage carried by an accompanying person who will ride on the taxi 10 with the user as well as a property of the baggage carried by the user. Whether there is an accompanying person may be determined based on whether there is a place by which the taxi 10 is to stop (and whether the place is in a residential area), whether there is another user who will participate in the same tour as the user, or schedule of the user. The property of the baggage carried by the accompanying person may be forecast in the same manner as the baggage carried by the user.

Features of the above described embodiments and modifications may be employed in any possible combination. In other words, processing and structure that have been described in this disclosure may be employed in any combination so long as it is technically feasible to do so. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (i.e. information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a non-transitory, computer-readable recording medium include any type of discs including magnetic discs, such as a floppy disc (registered trademark) and a hard disk drive (HDD), and optical discs, such as a CD-ROM, a DVD, and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus for managing dispatch of a vehicle to a user, comprising a controller including at least one processor, the controller being configured to execute the processing of;
forecasting a property of baggage that the user will carry when going out somewhere; and
sending offer information to a terminal used by the user, the offer information being information for offering dispatch of a type of vehicle that is suitable for the forecast property of the baggage.

2. The information processing apparatus according to claim 1, wherein the property of the baggage comprises information about the sizes and the number of bags that the user will carry when going out somewhere, and the controller forecasts the sizes and the number of bags that the user will carry when going out somewhere by determining the sizes and the numbers of bags that the user has packed before going out somewhere on the basis of information acquired by a specific sensor.

3. The information processing apparatus according to claim 2, wherein
the specific sensor comprises location sensors respectively attached to a plurality of bags that the user has,
the information processing apparatus further comprises a storage unit in which information that links the location sensors for the respective bags that the user has and the sizes of the respective bags is stored, and
the controller determines the sizes and the number of bags that the user has packed before going out somewhere by executing the processing of;
finding a bag that has been moved from a specific storage place from among the plurality of bags on the basis of information acquired by the location sensors to determine that the bag thus found has been packed by the user; and
determining the size of the bag determined to have been packed by the user on the basis of the location sensor attached to the bag determined to have been packed by the user and the information stored in the storage unit.

4. The information processing apparatus according to claim 2, wherein
the specific sensor comprises object detection sensors respectively attached to a plurality of bags that the user has,
the information processing apparatus further comprises a storage unit in which information that links the object detection sensors for the respective bags that the user has and the sizes of the respective bags is stored, and
the controller determines the sizes and the number of bags that the user has packed before going out somewhere by executing the processing of;
finding a bag of which the number of objects stored therein has changed from among the plurality of bags on the basis of information acquired by the object detection sensors to determine that the bag thus found has been packed by the user; and
determining the size of the bag determined to have been packed by the user on the basis of the object detection sensor attached to the bag determined to have been packed by the user and the information stored in the storage unit.

5. The information processing apparatus according to claim 2, wherein
the specific sensor comprises a camera, and
the controller determines the sizes and the number of bags that have been packed by the user on the basis of an image captured by the camera.

6. The information processing apparatus according to claim 2, wherein the controller sends the offer information to the terminal, triggered by forecasting of the sizes and the number of bags that the user will carry when going out somewhere.

7. The information processing apparatus according to claim 1, wherein the property of baggage comprises information about the sizes and the number of bags that the user will carry when going out somewhere, and the controller forecasts the sizes and the number of bags that the user will carry when going out somewhere on the basis of at least one of information about a period through which the user is scheduled to be out, information about a destination to which the user will go, and information about the gender of the user.

8. The information processing apparatus according to claim 7, wherein the controller sends the offer information to the terminal a predetermined time earlier than the beginning of the period through which the user is scheduled to be out.

9. The information processing apparatus according to claim 1, wherein
the property of the baggage comprises information about the sizes and the number of bags that the user will carry when going out somewhere, and
in the case where the user will go out from a stay facility after checking out from it, the controller forecasts the sizes and the number of bags that the user will carry when going out somewhere on the basis of the sizes and the number of bags that the user carried at the time when the user checked in at the stay facility.

10. The information processing apparatus according to claim 9, wherein the controller sends the offer information to the terminal a predetermined time earlier than the time at which the user is scheduled to check out from the stay facility.

11. The information processing apparatus according to claim 2, wherein the controller sends information for offering dispatch of a vehicle having a baggage space that can accommodate the forecast sizes and number of bags to the terminal as the offer information.

12. An information processing method for managing dispatch of a vehicle to a user, comprising the following steps of processing executed by a computer:
a first step of forecasting a property of baggage that the user will carry when going out somewhere; and
a second step of sending offer information to a terminal used by the user, the offer information being information for offering dispatch of a type of vehicle that is suitable for the forecast property of the baggage.

13. The information processing method according to claim 12, wherein
the property of the baggage comprises information about the sizes and the number of bags that the user will carry when going out somewhere, and
in the first step, the computer forecasts the sizes and the number of bags that the user will carry when going out somewhere by determining the sizes and the numbers of bags that the user has packed before going out somewhere on the basis of information acquired by a specific sensor.

14. The information processing method according to claim 13, wherein
the specific sensor comprises location sensors respectively attached to a plurality of bags that the user has,
the computer further comprises a storage unit in which information that links the location sensors for the respective bags that the user has and the sizes of the respective bags is stored, and
in the first step, the computer determines the sizes and the number of bags that the user has packed before going out somewhere by executing the processing of;
finding a bag that has been moved from a specific storage place from among the plurality of bags on the basis of information acquired by the location sensors to determine that the bag thus found has been packed by the user; and
determining the size of the bag determined to have been packed by the user on the basis of the location sensor attached to the bag determined to have been packed by the user and the information stored in the storage unit.

15. The information processing method according to claim 13, wherein
the specific sensor comprises object detection sensors respectively attached to a plurality of bags that the user has,
the computer further comprises a storage unit in which information that links the object detection sensors for the respective bags that the user has and the sizes of the respective bags is stored, and
in the first step, the computer determines the sizes and the number of bags that the user has packed before going out somewhere by executing the processing of;
finding a bag of which the number of objects stored therein has changed from among the plurality of bags on the basis of information acquired by the object detection sensors to determine that the bag thus found has been packed by the user; and
determining the size of the bag determined to have been packed by the user on the basis of the object detection sensor attached to the bag determined to have been packed by the user and the information stored in the storage unit.

16. The information processing method according to claim 13, wherein
the specific sensor comprises a camera, and
in the first step, the computer determines the sizes and the number of bags that have been packed by the user on the basis of an image captured by the camera.

17. The information processing method according to claim 13, wherein in the second step, the computer sends the offer information to the terminal, triggered by forecasting of the sizes and the number of bags that the user will carry when going out somewhere.

18. The information processing method according to claim 12, wherein the property of the baggage comprises information about the sizes and the number of bags that the user will carry when going out somewhere, and
in the first step, the computer forecasts the sizes and the number of bags that the user will carry when going out somewhere on the basis of at least one of information about a period through which the user is scheduled to be out, information about a destination to which the user will go, and information about the gender of the user.

19. The information processing method according to claim 18, wherein in the second step, the computer sends the offer information to the terminal a predetermined time earlier than the beginning of the period through which the user is scheduled to be out.

20. A non-transitory storage medium storing an information processing program for managing dispatch of a vehicle to a user, the information processing program being configured to cause a computer to execute the following steps of processing:
a first step of forecasting a property of baggage that the user will carry when going out somewhere; and
a second step of sending offer information to a terminal used by the user, the offer information being information for offering dispatch of a type of vehicle that is suitable for the forecast property of the baggage.
